(19) United States
(12) Patent Application Publication
(10) Pub. No.: US 2011/0030593 A1
(43) Pub. Date: Feb. 10, 2011

(54) Method for desulfurizing a fluid and methods for operating a coal combustion system

(75) Inventor: Chandrashekhar Sonwane, Philadelphia, PA (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 12/538,434

(22) Filed: Aug. 10, 2009

(51) Int. Cl. F23J 15/02; B01D 53/50

(52) U.S. Cl. 110/345; 423/244.01

(57) ABSTRACT

A method for desulfurizing a fluid comprising at least one sulfur compound is provided. The method includes providing an oxide composition comprising at least one byproduct oxide from a process for removing one or more impurities from coal and contacting the oxide composition with the fluid. The oxide composition reacts with the at least one sulfur compound to form a solid precipitate. Methods for operating a coal combustion system are also provided.

### TECHNICAL FIELD

This disclosure generally relates to methods for desulfurizing a fluid including sulfur compounds, and more particularly relates to methods for desulfurizing a flue gas using byproduct oxides from a process for removing impurities from coal.

### BACKGROUND OF THE INVENTION

Combustion of various types of coal, including ultra clean coal, may produce sulfur compounds such as sulfur dioxide (SO₂) and sulfur trioxide (SO₃) in the flue gas. In many countries, there are regulations which require strict limits on the emission of sulfur compounds such as SO₂ and SO₃, as they may cause acid rain, visibility impairment, respiratory problems, damage to plants, and pollution of water.

Existing flue gas desulfurization units (FGDs) are either wet scrubbers or dry scrubbers. Wet scrubbers spray a liquid sorbent into the flue gas in a spray tower. Limestone or slake lime is used as a sorbent. Sulfur oxides react with the sorbent to form calcium sulfate (CaSO₄) or calcium sulfite (CaSO₃), which can be oxidized to form gypsum. The gypsum can then be sold as a useful product in cement or soil applications. In dry scrubbers, a slurry of alkaline (e.g., lime or sodium based) reagent is sprayed into a tower.

### SUMMARY OF THE INVENTION

This disclosure provides a method for desulfurizing a fluid comprising at least one sulfur compound. The method includes providing an oxide composition comprising at least one byproduct oxide from a process for removing one or more impurities from coal and contacting the oxide composition with the fluid. The oxide composition reacts with the at least one sulfur compound to form a solid precipitate.

The present disclosure also provides a method for operating a coal combustion system. The method comprises providing coal comprising a plurality of impurities and removing one or more of the impurities from the coal to produce at least one byproduct oxide. The at least one byproduct oxide comprises one or more of the impurities, a product of a reaction between one or more of the impurities and at least one reactant, or both. The method further includes separating the at least one byproduct oxide from the coal, combusting the coal to produce a flue gas comprising at least one sulfur compound, and contacting the at least one byproduct oxide with the flue gas. The at least one byproduct oxide reacts with the at least one sulfur compound to form a solid precipitate.

The present disclosure further provides another method for operating a coal combustion system. The method comprises providing coal comprising a plurality of impurities, reacting a fluoride compound with an acid to produce hydrofluoric acid and a byproduct oxide, contacting the hydrofluoric acid with the coal to remove one or more of the impurities from the coal, separating the hydrofluoric acid from the coal, combusting the coal to produce a flue gas comprising at least one sulfur compound, and contacting the byproduct oxide with the flue gas. The byproduct oxide reacts with the at least one sulfur compound in the flue gas to form a solid precipitate.

Other aspects, features, and advantages of this invention will be apparent from the following detailed description, drawings, and claims.

### BRIEF DESCRIPTION OF DRAWINGS

FIG. 1 illustrates a process 10 for removing impurities from coal which produces byproduct oxides in accordance with an embodiment of the present invention.

FIG. 2 illustrates a method 60 for desulfurizing a flue gas comprising sulfur compounds accordance with an embodiment of the present invention.

### DETAILED DESCRIPTION OF EMBODIMENTS

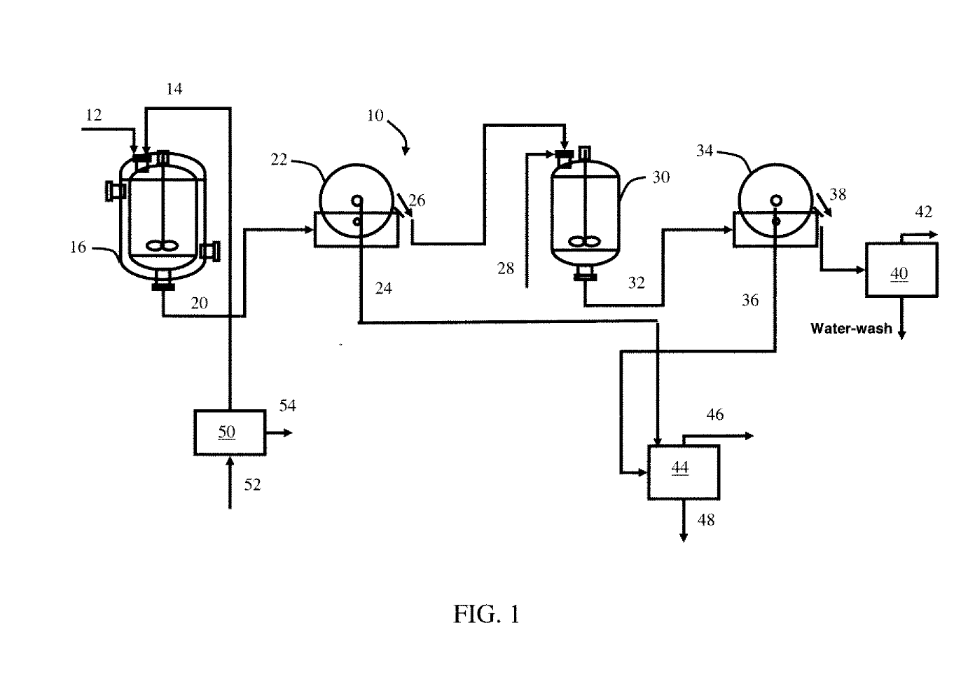

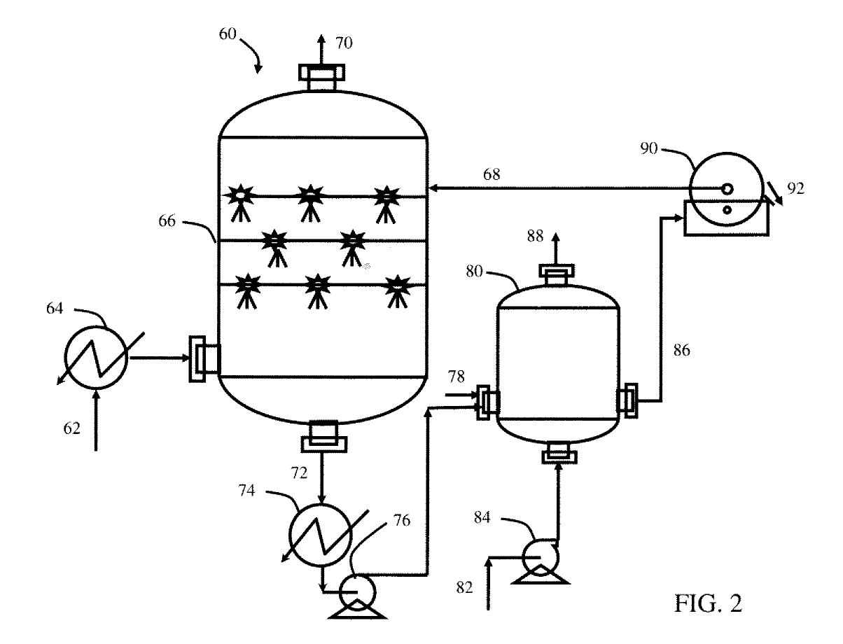

As summarized above, this disclosure encompasses a method for desulfurizing a fluid and methods for operating a coal combustion system. It should be understood that any system such as gas turbine systems (e.g., coal fired gas turbine systems, pulverized coal power plants, and integrated gasification combined cycle systems) or the like may use the embodiments of the methods for desulfurizing a fluid and methods for operating a coal combustion system of the present disclosure. An embodiment of operating a coal combustion system is described below and illustrated in FIGS. 1 and 2. FIG. 1 illustrates a process 10 for removing one or more impurities from coal 12 before combustion of the coal in the coal combustion system.

The method 10 first provides coal 12 comprising a plurality of impurities. Embodiments of method 10 may provide coal 12 in the form of anthracite coal, bituminous coal, subbituminous coal, lignite coal, or combinations thereof.

In some embodiments, the impurities include, but are not limited to, oxides of aluminum, iron, potassium, calcium, sodium, and other metals, minerals, inorganic and organic sulfur compounds, alkalis, ash, or combinations thereof. As used herein, “ash” refers to both the non-combustible components in the coal before combustion and the non-combustible byproducts resulting from combustion of the coal, including slag and fly ash. In certain embodiments, the impurities may be present in the coal 12 in an amount ranging from about 2 wt. % to about 50 wt. %. In other embodiments, the impurities may be present in the coal 12 in an amount ranging from about 3 wt. % to about 8 wt. %. In still other embodiments, the impurities may be present in the coal 12 in an amount ranging from about 5 wt. % to about 7 wt. %.

TABLE 1
Examples of ranges of chemical composition for fly ash produced
from different coal types (expressed as percent by weight).

| Component | Bituminous | Subbituminous | Lignite |
|---|---|---|---|
| SiO₂ | 20-60 | 40-60 | 15-45 |
| Al₂O₃ | 5-35 | 20-30 | 10-25 |
| Fe₂O₃ | 10-40 | 4-10 | 4-15 |
| CaO | 1-12 | 5-30 | 15-40 |
| MgO | 0-5 | 1-6 | 3-10 |
| SO₃ | 0-4 | 0-2 | 0-10 |
| Na₂O | 0-4 | 0-2 | 0-6 |
| K₂O | 0-3 | 0-4 | 0-4 |
| LOI | 0-15 | 0-3 | 0-5 |

Source: http://www.tfhrc.gov

The method 10 contacts the coal 12 with a first leaching solution 14 in a first reactor 16. In one embodiment, the first leaching solution 14 may comprise an acid as a first reactant. In some embodiments, the first leaching solution 14 may include, but is not limited to, a hydrofluoric acid solution, a nitric acid solution, a hydrochloric acid solution, a hydrofluorosilicic acid solution, a combination thereof, or other solutions of strong acids that dissolve oxides.

In one embodiment, the first leaching solution 14 reacts with one or more of the impurities to produce at least one first byproduct oxide. In another embodiment, the first leaching solution 14 reacts with the coal 12 to remove one or more of the impurities to produce a first byproduct oxide. In certain embodiments, the first leaching solution 14 may both react with an impurity to produce a first byproduct oxide and remove an impurity from the coal 12 as a first byproduct oxide.

In particular embodiments, the first byproduct oxides may comprise metal oxides. For example, the first byproduct oxides may be metal oxide impurities which are removed from the coal by the first leaching solution 14. In some embodiments, the first byproduct oxides may comprise potassium oxide, sodium oxide, silicon oxide, aluminum oxide, iron oxide, or combinations thereof. In other embodiments, the first byproduct oxides may be further reacted with water to form a hydrate (e.g., metal oxide hydrate). In certain embodiments, the first byproduct oxides may be soluble in the first leaching solution 14.

In particular embodiments, additional reactions may result from contacting the first leaching solution 14 with the coal 12 to produce one or more first products soluble in the first leaching solution. In some embodiments, the first products comprise one or more fluorides, hydroxides, hydroxyfluorides, oxides, or combinations thereof. In embodiments where the first products comprise one or more fluorides, the fluorides may be silicon fluoride, aluminum fluoride, iron fluoride, calcium fluoride, sodium fluoride, or combinations thereof. An example of an additional reaction of the first leaching solution 14 with an impurity in the coal 12 is given below in Formula (I):

SiO₂+4HF→SiF₄+2H₂O (I).

In certain embodiments, the first leaching solution 14 has a first reactant concentration ranging from about 3 M to about 10 M. In other embodiments, the first leaching solution 14 has a first reactant concentration ranging from about 3 M to about 6 M. In still other embodiments, the first leaching solution 14 has a first reactant concentration ranging from about 4 M to about 6 M.

In particular embodiments, the weight ratio of first leaching solution 14 to coal 12 added to the first reactor 16 ranges from about 10:1 to about 10:5. Unless otherwise indicated, all ratios are weight to weight ratios. In other particular embodiments, the weight ratio of first leaching solution 14 to coal 12 added to the first reactor 16 ranges from about 10:2 to about 10:4. In still other particular embodiments, the weight ratio of first leaching solution 14 to coal 12 added to the first reactor 16 ranges from about 10:2.5 to about 10:3.5.

In certain embodiments, the first leaching solution 14 comprises a hydrofluoric acid solution having a hydrofluoric acid concentration ranging from about 3 M to about 10 M. In other embodiments, the first leaching solution 14 comprises a hydrofluoric acid solution having a hydrofluoric acid concentration ranging from about 3 M to about 6 M. In still other embodiments, the first leaching solution 14 comprises a hydrofluoric acid solution having a hydrofluoric acid concentration ranging from about 4 M to about 6 M. In particular embodiments, the weight ratio of hydrofluoric acid solution 14 to coal 12 added to the first reactor 16 ranges from about 10:1 to about 10:5. In other particular embodiments, the weight ratio of hydrofluoric acid solution 14 to coal 12 added to the first reactor 16 ranges from about 10:2 to about 10:4. In still other particular embodiments, the weight ratio of hydrofluoric acid solution 14 to coal 12 added to the first reactor 16 ranges from about 10:2.5 to about 10:3.5.

In particular embodiments, the coal 12 is in contact with the first leaching solution 14 for about 1 hours to about 10 hours in the first reactor 16. In other particular embodiments, the coal 12 is in contact with the first leaching solution 14 for about 3 hour to about 5 hours in the first reactor 16. In still other particular embodiments, the coal 12 is in contact with the first leaching solution 14 for about 4 hours to about 5 hours in the first reactor 16.

In particular embodiments, the coal 12 is in contact with the first leaching solution 14 at a temperature ranging from about 70° F. to about 200° F. in the first reactor 16. In other particular embodiments, the coal 12 is in contact with the first leaching solution 14 at a temperature ranging from about 110° F. to about 170° F. in the first reactor 16. In still other particular embodiments, the coal 12 is in contact with the first leaching solution 14 at a temperature ranging from about 140° F. to about 160° F. in the first reactor 16.

In particular embodiments, the coal 12 is in contact with the first leaching solution 14 at a pressure ranging from about 14 psia to about 1000 psia in the first reactor 16. In other particular embodiments, the coal 12 is in contact with the first leaching solution 14 at a pressure ranging from about 14 psia to about 42 psia in the first reactor 16. In still other particular embodiments, the coal 12 is in contact with the first leaching solution 14 at a pressure ranging from about 14 psia to about 20 psia in the first reactor 16.

The method 10 further comprises separating at least a portion of the first leaching solution 14 from the coal 12. By separating at least a portion of the first leaching solution 14 from the coal 12, at least a portion of the first byproduct oxides which are soluble in the first leaching solution and at least a portion of the first products are also separated from the coal. Thus, in particular embodiments, substantially all of the first leaching solution 14 including substantially all of the first byproduct oxides and substantially all of the first products may be separated from the coal 12. In the method 10 illustrated in FIG. 1, the first leaching solution 14, the first byproduct oxides, the first products, and the coal 12 are transported from the first reactor 16 as a slurry 20 to a drum filter 22. The drum filter 22 filters the slurry 20 to separate the coal as wet coal 26 from the first leaching solution, the first byproduct oxides, and the first products as a first filtrate 24.

The wet coal 26 is then fed to a second reactor 30 where the coal 12 are contacted with a second leaching solution 28. In one embodiment, the second leaching solution 28 may comprise a nitrate solution including nitrates as a second reactant. In certain embodiments, the second leaching solution 28 comprises a second reactant including, but not limited to nitric acid, aluminum nitrate, ferric nitrate, fluoronitrate, other nitrates, hydroxide, hydroxyl fluoride, hydroxynitrate, ions thereof, or combinations thereof.

In one embodiment, the second leaching solution 28 reacts with one or more of the impurities to produce at least one second byproduct oxide. In another embodiment, the second leaching solution 28 reacts with the wet coal 26 to remove one or more of the impurities to produce a second byproduct oxide. In certain embodiments, the second leaching solution 28 may both react with an impurity to produce a second byproduct oxide and remove an impurity from the wet coal 26 as a second byproduct oxide. In particular embodiments, the second byproduct oxides may comprise oxides which are the same or similar to the first byproduct oxides. In certain embodiments, the second byproduct oxides may be soluble in the second leaching solution 28.

In certain embodiments, additional reactions may result from contacting the second leaching solution 28 with the wet coal 26 to produce second products soluble in the second leaching solution. Examples of additional reactions of the second leaching solution 28 with impurities in the coal 26 are given below in Formulas (II) and (III):

FeS₂+14Fe(NO₃)₃+8H₂O→2SO₄²⁻+16H⁺+15Fe²⁺+42NO³⁻ (II)

SiF₄+2(Al,Fe)(NO₃)₃+2H₂O→SiO₂₍ₛ₎+2(Al,Fe)F₂⁺+4H⁺+6NO₃⁻ (III).

In another example, silicon fluoride may react with the second leaching solution 28 to form silicon oxide solid precipitate. In another embodiment, calcium fluoride (CaF₂) solid precipitate formed in the first reactor 14, which is present in the wet coal 26, dissolves in the second reactor 30 when it reacts with the second leaching solution 28 to form soluble nitrates or nitro/hydroxyl/fluorides. An example of such a reaction is given below in Formula (IV):

CaF₂(s)+Fe³⁺(aq)→CaF₂(aq)+Ca²⁺(aq) (IV).

In some embodiments of the method 10, the one or more second products comprise nitrate ions, sulfate ions, iron ions, hydroxyfluorides, oxides, fluoro nitrates, or combinations thereof. Iron sulfide (FeS₂), solids present in the coal 12 are dissolved in the second reactor 30.

In particular embodiments, the second leaching solution 28 has a second reactant concentration ranging from about 0.1 M to about 5 M. In other particular embodiments, the second leaching solution 28 has a second reactant concentration ranging from about 0.1 M to about 0.4 M. In still other particular embodiments, the second leaching solution 28 has a second reactant concentration ranging from about 0.1 M to about 0.3 M.

In certain embodiments, the weight ratio of second leaching solution 28 to wet coal 26 added to the second reactor 30 ranges from about 10:1 to about 10:5. In other embodiments, the weight ratio of second leaching solution 28 to wet coal 26 added to the second reactor 30 ranges from about 10:2 to about 10:4. In still other embodiments, the weight ratio of second leaching solution 28 to wet coal 26 added to the second reactant reactor 30 ranges from about 10:2.5 to about 10:3.5.

In particular embodiments, the second leaching solution 28 comprises a nitric acid solution having a nitric acid concentration ranging from about 0.1 M to about 5 M. In other particular embodiments, the second leaching solution 28 comprises a nitric acid solution having a nitric acid concentration ranging from about 0.1 M to about 0.4 M. In still other particular embodiments, the second leaching solution 28 comprises a nitric acid solution having a nitric acid concentration ranging from about 0.2 to about 0.3 M. In certain embodiments, the weight ratio of nitric acid solution 28 to wet coal 26 added to the second reactor 30 ranges from about 10:1 to about 10:5. In other embodiments, the weight ratio of nitric acid solution 28 to wet coal 26 added to the second reactor 30 ranges from about 10:2 to about 10:4. In still other embodiments, the weight ratio of nitric acid solution to 28 to wet coal 26 added to the second reactor 30 ranges from about 10:2.5 to about 10:3.5.

According to certain embodiments of the present disclosure, the second leaching solution 28 is in contact with the wet coal 26 for about 20 hours to about 30 hours in the second reactor 30. In other particular embodiments, the second leaching solution 28 is in contact with the wet coal 26 for about 22 hours to about 26 hours in the second reactor 30.

In particular embodiments, the second leaching solution 28 is in contact with the wet coal 26 at a temperature ranging from about 70° F. to about 190° F. in the second reactor 30. In other particular embodiments, the second leaching solution 28 is in contact with the wet coal 26 at a temperature ranging from about 150° F. to about 190° F. in the second reactor 30. In still other particular embodiments, the second leaching solution 28 is in contact with the wet coal 26 at a temperature ranging from about 140° F. to about 160° F. in the second reactor 30.

In particular embodiments, the second leaching solution 28 is in contact with the wet coal 26 at a pressure ranging from about 14.4 psia to about 100 psia in the second reactor 30. In other particular embodiments, the second leaching solution 28 is in contact with the wet coal 26 at a pressure ranging from about 14.4 psia to about 43 psia in the second reactor 30. In still other particular embodiments, the second leaching solution 28 is in contact with the wet coal 26 at a pressure ranging from about 14.4 psia to about 28 psia in the second reactor 30.

The method 10 further comprises separating at least a portion of the second leaching solution 28 from the coal. By separating at least a portion of the second leaching solution 28 from the coal, at least a portion of the second byproduct oxides soluble in the second leaching solution and at least a portion of the second products are also separated from the coal. Thus, in particular embodiments, substantially all of the second leaching solution 28 including substantially all of the second byproduct oxides and substantially all of the second products may be separated from the coal. In the method 10 illustrated in FIG. 1, the second leaching solution 28, the second byproduct oxides, the second products, and the coal are transported from the second reactor 30 as a slurry 32 to a drum filter 34. The drum filter 34 filters the slurry 32 to separate wet coal 38 from the second leaching solution, the second byproduct oxides, and the second products as a second filtrate 36.

The method 10 may further comprise washing the wet coal 38 with water in a water wash apparatus 40 to remove any residual reactants or products from the coal. The water-washed coal 42 may be transferred to a coal dryer (not shown) over a conveyer belt (not shown), which will further act as a filter to remove water from the coal.

Ash may be present in particular embodiments of the water-washed coal 42 in an amount less than about 0.2% by weight. In certain embodiments of the method 10, ash is present in the water-washed coal 42 in an amount ranging from about 0.01% by weight to about 0.5% by weight. In other embodiments of the method 10, ash is present in the water-washed coal 42 in an amount ranging from about 0.01% by weight to about 0.2% by weight. In certain embodiments, the water-washed coal 42 may include trace amounts of fluorides, nitrates, oxides, or a combination thereof.

Thus, the method of the present disclosure may be used to produce ultra clean coal. As used herein, the term “ultra clean coal” refers to coal having a reduced ash content (e.g., below about 0.2%) and/or a substantially reduced sulfur content such that the coal may be fed directly into processes such as gas turbine processes and provide advantages such as improved thermal efficiency, for example.

In particular embodiments, the method further comprises agitating the first leaching solution in the first reactor, agitating the second leaching solution in the second reactor, or both. In alternate embodiments, more or less leaching solutions may be utilized.

In alternate embodiments (not shown), the methods may be carried out in one reaction chamber in a batch process to avoid transfer of chemicals and use of multiple reactors, multiple filters, and conveying equipment (e.g., pumps and conveyer belts) an associated costs and space requirements. In addition, exposure of coal outside of the reactor is reduced, thus reducing coal losses and avoiding hazards associated with transfer of chemicals.

The first filtrate 24 and the second filtrate 36 may be further processed by additional apparatuses 44 (e.g., filters, distillation columns, etc.) to recover the first leaching solution 14, the second leaching solution 28, or precursors thereof as recovered reactants 48 (e.g., hydrofluoric acid, nitrates, etc.), while leaving a byproduct oxide stream 48.

In addition, the first leaching solution 14 may be generated in the coal combustion system in a first leaching solution reactor 50 from precursors 52. The generation of the first leaching solution 14 may result in at least one third byproduct oxide 54. For example, the first leaching solution 14 may comprise hydrofluoric acid which made from the precursors 52 calcium fluoride and sulfuric acid. The third byproduct oxide 54 resulting from this generation of hydrofluoric acid may comprise calcium oxide. Advantageously, generation of hydrofluoric acid in the coal combustion system avoids transport of the hydrofluoric acid to the coal generation system, which avoids the associated safety concerns, and produces a third byproduct oxide 54, which may be used for desulfurization of a fluid such as a flue gas.

FIG. 2 illustrates an embodiment of a method 60 for desulfurizing a flue gas comprising at least one sulfur compound. The flue gas 62 resulting from combustion (not shown) of coal is fed into a heat exchanger 64 to adjust the temperature of the flue gas 62 to the appropriate temperature for the desulfurization. Though, a portion of the heat of the flue gas 62 may removed by the heat exchanger 64, it should be understood that reducing the temperature of the flue gas may result in the formation of sulfuric and sulfurous acids, which may corrode ducts, pipes, and flue gas desulfurization unit components, due to the condensation of water vapor in the flue gas. Thus, a person of ordinary skill in the art would understand how to adjust the amount of heat exchanged in heat exchanger 64 as appropriate to avoid or reduce the condensation of water vapor in the flue gas 62. It also should be understood by a person of ordinary skill in the art that the temperature of the flue gas may be adjusted accordingly based on the type of oxide composition and/or other sorbent used, the amount of oxide composition and/or other sorbent used, and various other process parameters.

Next, the flue gas is then fed into the flue gas desulfurization unit (FGD) 66, where it is contacted with an oxide composition 68. In certain embodiment, the FGD 66 may comprise a wet scrubber (e.g., a spray tower), a dry scrubber, or the like. In certain embodiments, the flue gas may comprise an inorganic sulfur compound. For example, the flue gas may comprise sulfur dioxide and/or sulfur trioxide (i.e., sulfur compounds resulting from combustion).

The oxide composition 68 includes one or more byproduct oxides described above from the method 10 for removing one or more impurities from coal. The oxide composition 68 reacts with at least one sulfur compound in the flue gas to form a solid precipitate 72. In one embodiment, the oxide composition 68 may comprise calcium oxide. Thus, the calcium oxide may react with sulfur compounds in the flue gas 62 such as sulfur dioxide and/or sulfur trioxide to form a solid precipitate 72 comprising calcium sulfite and/or calcium sulfate, respectively, as shown in the following Formulas (IV) and (V):

SO₂+CaO→Ca²⁺+SO₃²⁻ (IV)

SO₃+CaO→Ca²⁺+SO₄²⁻ (V).

In other embodiments, other oxides, such as sodium oxide, aluminum oxide, and ferrous oxide, may be present in the oxide composition 68 and may react with at least one sulfur compound in the flue gas to produce corresponding sulfates or sulfites.

The desulfurized flue gas 70 then exits the top of the FGD 66 while the solid precipitate 72 exits the bottom of the FGD 66. In some embodiments, sulfur compounds may be present in the desulfurized flue gas 70 in an amount ranging from about 10 ppm to about 300 ppm. In other embodiments, sulfur compounds may be present in the desulfurized flue gas 70 in an amount ranging from about 100 ppm to about 500 ppm. In still other embodiments, sulfur compounds may be present in the desulfurized flue gas 70 in an amount ranging from about 50 ppm to about 80 ppm.

As illustrated in FIG. 2, the solid precipitate 72 comprises calcium sulfite and calcium sulfate and is further processed to form gypsum (i.e., CaSO₄.2H₂O). In particular, the solid precipitate 72 is sent to a heat exchanger 74 and then is transported by a pump 76 to a third reactor 80. It should be understood by a person of ordinary skill in the art that the temperature of the solid precipitate 72 may be adjusted accordingly based on the desired reaction temperature in the third reactor 80 and various other process parameters. It should also be understood that, in particular embodiments, the reaction of flue gases, such as SO₂ or SO₃, with metal oxides is exothermic and there may be a need to reduce the temperature of the solid precipitate 72 so that less expensive materials of construction may be used in the method 60.

The byproduct oxides 82 from the method 10 for removing one or more impurities are also transported by a pump 84 to the third reactor 80. In certain embodiments, the byproduct oxides 82 may comprise the first byproduct oxides, the second byproduct oxides, the third byproduct oxides 54, the byproduct oxide stream 48, or combinations thereof. An oxidation acid 78 is also feed into the third reactor 80. Water and oxygen are further fed into the third reactor 80 as part of the solid precipitate 72 stream, the oxidation acid 78 stream, and/or the byproduct oxides 82 stream or as separate streams (not shown). Thus, the third reactor 80 converts the solid precipitate 72 into gypsum as shown in the following Formulas (VI), (VII), and (VIII):

2HSO₃⁻+O_{2(g)}→2SO₄²⁻+2H⁺ (VI)

2SO₃²⁻+O_{2(g)}→2SO₄²⁻ (VII)

Ca²⁺+SO₄²⁻+2H₂O→CaSO₄.2H₂O₍ₛ₎ (VIII).

Any resulting gas 88 is released and the gypsum 92 is filtered from the remaining water, soluble byproduct oxides, byproduct oxide hydrates (i.e., the oxide composition 68) by a drum filter 90.

By using byproduct oxides from the coal cleaning process for flue gas desulfurization, the amount of limestone, lime, and/or other alkali materials required as sorbents for removing sulfur compounds from the flue gas is reduced. Thus, the embodiments of the disclosed methods may remove a substantial portion or all of the inorganic sulfur compounds from the coal using the leaching solution(s) and remove a substantial portion or all of the organic sulfur compounds rough the desulfurization of the flue gas.

It should be apparent that the foregoing relates only to the preferred embodiments of the present application and that numerous changes and modifications may be made herein by one of ordinary skill in the art without departing from the generally spirit and scope of the invention as defined by the following claims and the equivalents thereof.

We claim:

1. A method for desulfurizing a fluid comprising at least one sulfur compound, the method comprising:
providing an oxide composition comprising at least one byproduct oxide produced by a process for removing one or more impurities from coal; and
contacting the oxide composition with the fluid, wherein the oxide composition reacts with the at least one sulfur compound to form a solid precipitate.

2. The method of claim 1, wherein the oxide composition comprises a metal oxide hydrate.

3. The method of claim 1, wherein the oxide composition comprises potassium oxide, calcium oxide, sodium oxide, aluminum oxide, ferrous oxide, or combinations thereof.

4. The method of claim 1, wherein the fluid comprises a flue gas.

5. The method of claim 1, wherein the at least one sulfur compound comprises an inorganic sulfur compound.

6. The method of claim 1, wherein the solid precipitate comprises calcium sulfite, calcium sulfate, or a combination thereof.

7. The method of claim 1, wherein, after the step of contacting, the at least one sulfur compound is present in the fluid in an amount ranging from about 10 ppm to about 100 ppm.

8. The method of claim 1, wherein the process for removing one or more impurities from coal comprises providing coal having a plurality of impurities, contacting the coal with at least one leaching solution, wherein the at least one leaching solution reacts with one or more of the impurities, removes one or more of the impurities from the coal, or both to produce the at least one byproduct oxide.

9. The method of claim 1, wherein the process for removing one or more impurities from coal comprises providing coal having a plurality of impurities, reacting a fluoride compound with an acid to produce hydrofluoric acid and the at least one byproduct oxide, and contacting the hydrofluoric acid with the coal to remove one or more of the impurities from the coal.

10. A method for operating a coal combustion system, the method comprising:
providing coal comprising a plurality of impurities;
removing one or more of the impurities from the coal to produce at least one byproduct oxide, the at least one byproduct oxide comprising one or more of the impurities, a product of a reaction between one or more of the impurities and at least one reactant, or both;
separating the at least one byproduct oxide from the coal;
combusting the coal to produce a flue gas comprising at least one sulfur compound; and
contacting the at least one byproduct oxide with the flue gas, wherein the at least one byproduct oxide reacts with the at least one sulfur compound to form a solid precipitate.

11. The method of claim 10, wherein the at least one byproduct oxide comprises a metal oxide hydrate.

12. The method of claim 10, wherein the at least one oxide byproduct oxide comprises potassium oxide, calcium oxide, sodium oxide, aluminum oxide, ferrous oxide, or combinations thereof.

13. The method of claim 10, wherein the at least one sulfur compound comprises an inorganic sulfur compound.

14. The method of claim 10, wherein, after the step of contacting, the at least one sulfur compound is present in the flue gas in an amount ranging from about 10 ppm to about 300 ppm.

15. The method of claim 10, wherein the step of removing comprises contacting the coal with at least one leaching solution comprising the at least one reactant.

16. A method for operating a coal combustion system, the method comprising:
providing coal comprising a plurality of impurities;
reacting a fluoride compound with an acid to produce hydrofluoric acid and a byproduct oxide;
contacting the hydrofluoric acid with the coal to remove one or more of the impurities from the coal;
separating the hydrofluoric acid from the coal;
combusting the coal to produce a flue gas comprising at least one sulfur compound; and
contacting the byproduct oxide with the flue gas, wherein the byproduct oxide reacts with the at least one sulfur compound to form a solid precipitate.

17. The method of claim 16, wherein the byproduct oxide comprises a metal oxide hydrate.

18. The method of claim 16, wherein the byproduct oxide comprises potassium oxide, calcium oxide, sodium oxide, aluminum oxide, ferrous oxide, or combinations thereof.

19. The method of claim 16, wherein the at least one sulfur compound comprises an inorganic sulfur compound.

20. The method of claim 16, wherein, after the step of contacting the byproduct oxide with the flue gas, the at least one sulfur compound is present in the flue gas in an amount ranging from about 10 ppm to about 300 ppm.
